(19) United States
(12) Patent Application Publication
(10) Pub. No.: US 2024/0408820 A1
(43) Pub. Date: Dec. 12, 2024

(54) Architectural 3D printer

(71) Applicant: Winsun technology INC., Irvine, CA (US)

(72) Inventor: Yihe MA, Irvine, CA (US)

(73) Assignee: Winsun technology INC., Irvine, CA (US)

(21) Appl. No.: 18/331,157

(22) Filed: Jun. 7, 2023

(30) Foreign Application Priority Data
Jun. 7, 2023 (CN) 2022213952775

(51) Int. Cl. B29C 64/236; B29C 64/209; B29C 64/232; B29C 64/25; B33Y 30/00

(52) U.S. Cl. CPC B29C 64/236; B29C 64/209; B29C 64/232; B29C 64/25; B33Y 30/00; B33Y 10/00

(57) ABSTRACT

The present application relates to the field of 3D printing technology, particularly to a 3D printer for architectural purposes. The 3D printer comprises a support frame and a print head. The support frame comprises a first support mechanism, a second support mechanism, and a third support mechanism. The second support mechanism is positioned along the second direction at an output end of the first support mechanism, and the third support mechanism is positioned along the third direction at an output end of the second support mechanism. The print head is positioned on an output end of the third support mechanism. The lengths of the second and third support mechanisms are adjustable along their respective directions. The first support mechanism comprises multiple support assemblies connected end to end along the first direction, and adjacent support assemblies can be connected and disconnected.

### FIELD OF INVENTION

This utility application relates to the field of 3D printing technology, particularly a 3D printer designed for architectural purposes.

### BACKGROUND

With the application of 3D printers in the field of architecture, there is an increasing demand for the printing head's range of movement and flexibility. Existing 3D printers consist of a support frame and a printing head, where the printing head is positioned at the output end of the 3D printer for printing walls and other objects. The dimensions of the support frame in the X, Y, and Z directions are large to accommodate the flexible printing range of the 3D printer. However, the on-site assembly or disassembly of the support frame is time-consuming, and the transportation and storage space required for the 3D printer are significant.

To address the aforementioned challenges, there is a pressing need for an architectural 3D printer that effectively solves the time-consuming process of assembling or disassembling the support frame on-site. Additionally, it should also address the difficulties associated with transportation and storage space constraints.

### SUMMARY OF THE INVENTION

The object of the present invention is to disclose an architectural 3D printer that enables quick on-site assembly and disassembly, reducing transportation and storage space requirements for the 3D printer.

To achieve this purpose, the present invention adopts the following technical solutions.
An architectural 3D printer comprising a support frame and a printing head, is disclosed. Wherein the support frame comprises the following.
A first support mechanism comprising a plurality of support assemblies connected end to end along the first direction, where adjacent support assemblies can be detachably connected.
A second support mechanism positioned at the output end of the first support mechanism along the second direction, where the length of the second support mechanism can extend along the second direction.
A third support mechanism positioned at the output end of the second support mechanism along the third direction, where the length of the third support mechanism can extend along the third direction. The printing head is positioned at the output end of the third support mechanism, and the first direction, the second direction, and the third direction are mutually perpendicular to each other.

As an optional feature, the first support mechanism further comprises:
A first driving assembly positioned between the support assemblies and the second support mechanism, where the first driving assembly is configured to drive the second support mechanism to move along the first direction.

As an optional feature, the first driving assembly comprises:
A first driving member positioned on the second support mechanism.
A driving wheel connected to the output end of the first driving member.
A rack meshing with the driving wheel, where the rack extends along the first direction and is positioned on the support assemblies.

As an optional feature, the second support mechanism comprises:
A second frame positioned on the first support mechanism.
A second driving assembly positioned on the second frame.
A moving frame slidingly engaged with the second driving assembly, where the second driving assembly is configured to drive the moving frame to move along the second direction, and the third support mechanism is positioned on the moving frame.

As an optional alternative embodiment, the second driving assembly includes:
The second driving member; and
The first servo slide, which is set along the second direction on the second frame. The moving frame is slidably connected to the first servo slide. The second driving member is configured to drive the moving frame to perform telescopic movement along the first servo slide.

As an optional feature, the third support mechanism includes:
The fixed seat, which is fixedly connected to the second support mechanism; and
The third driving assembly, which is slidably connected to the fixed seat. The third driving assembly is capable of driving the fixed seat to move along the third direction.

As an optional feature, the third support mechanism further includes:
The fourth driving assembly, which is installed on the third driving assembly. The printing head is set at the output end of the fourth driving assembly. The fourth driving assembly is capable of driving the printing head to perform telescopic movement along the third direction.

As an optional feature, the third support mechanism further includes:
The first guiding assembly, which is set between the printing head and the third driving assembly. The first guiding assembly is configured to guide the printing head to move along the third direction.

As an optional feature, the first guiding assembly includes:
The first mounting frame, which is set at the output end of the fourth driving assembly and fixedly connected to the printing head;
The second mounting frame, which is set on the third driving assembly; and
The guide rod, one end of which is fixed to either the first mounting frame or the second mounting frame. The first mounting frame and the second mounting frame, where the guide rod is not fixed, have guide holes extending along the third direction. The guide rod is capable of sliding in the guide holes.

As an optional feature, the architectural 3D printer further includes a moving assembly. The moving assembly is set on the first support mechanism and is configured to move and support the first support mechanism.

The advantageous effects of the present patent application are as follows:

This embodiment provides an architectural 3D printer comprising a support frame and a printing head. The printing head is set at the output end of the support frame. The support frame includes a first support mechanism, a second support mechanism, and a third support mechanism. The first support mechanism is set along the first direction, the second support mechanism is set at the output end of the first support mechanism along the second direction, and the third support mechanism is set at the output end of the second support mechanism along the third direction. The second support mechanism is capable of extending and retracting along the second direction, and the third support mechanism is capable of extending and retracting along the third direction, which is beneficial for reducing the volume of the 3D printer and facilitating transportation. The first support mechanism comprises a plurality of support assemblies connected end to end along the first direction, and adjacent support assemblies can be detachably connected. This allows operators to quickly assemble and disassemble the support assemblies on-site, improving the efficiency of on-site assembly and disassembly. Each support assembly has a smaller length, eliminating the need for lifting equipment for assembly and reducing assembly and disassembly costs. It also reduces the volume during the transportation process of the first support mechanism, thereby reducing transportation costs. At the same time, the assembly and connection of a plurality of support assemblies facilitate the selection of the length of the first support mechanism according to requirements, enhancing the flexibility and applicability scenarios of the 3D printer.

### DETAIL DESCRIPTION OF THE EMBODIMENTS

In order to further illustrate the technical solutions in the embodiments of the present patent application, a brief introduction of the accompanying drawings used in the description of the embodiments will be provided. It is apparent that the following description and accompanying drawings are merely some embodiments of the present patent application. Those skilled in the art will recognize, without exercising creative effort, that other accompanying drawings can be obtained based on the content of the embodiments and these accompanying drawings.

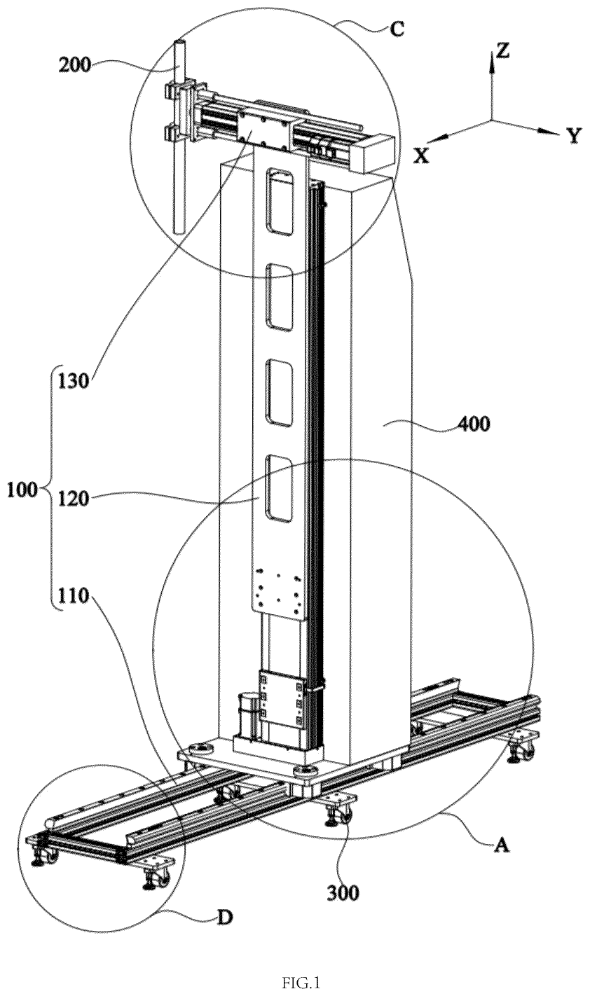

FIG. 1 is a schematic illustration of the structure of an architectural 3D printer provided in an embodiment of the present patent application.

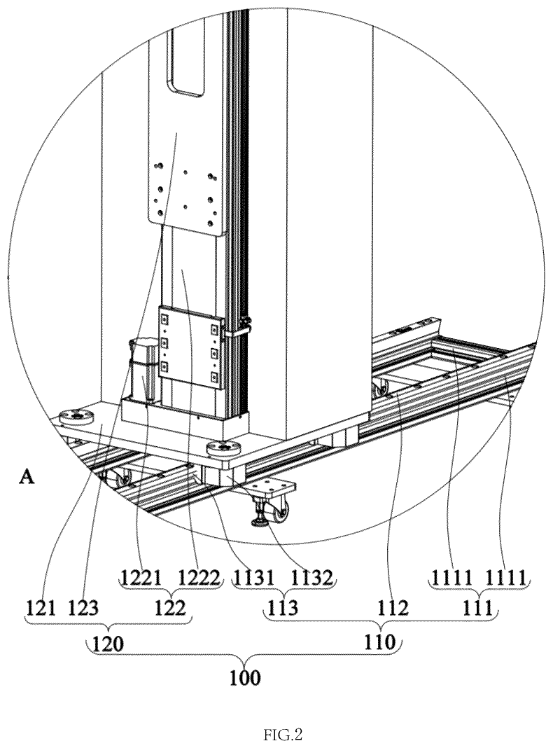

FIG. 2 is an enlarged partial view of area A in FIG. 1.

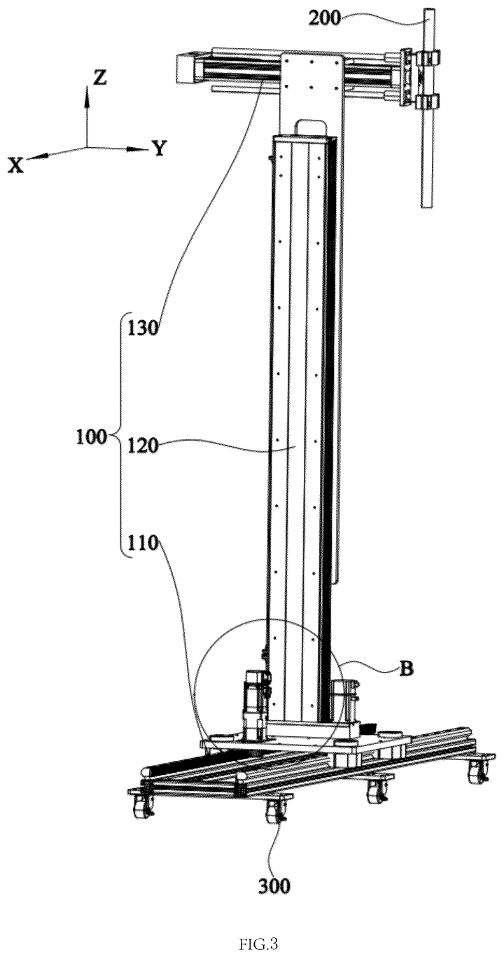

FIG. 3 is a schematic illustration of the structure of an architectural 3D printer provided in another embodiment of the present patent application.

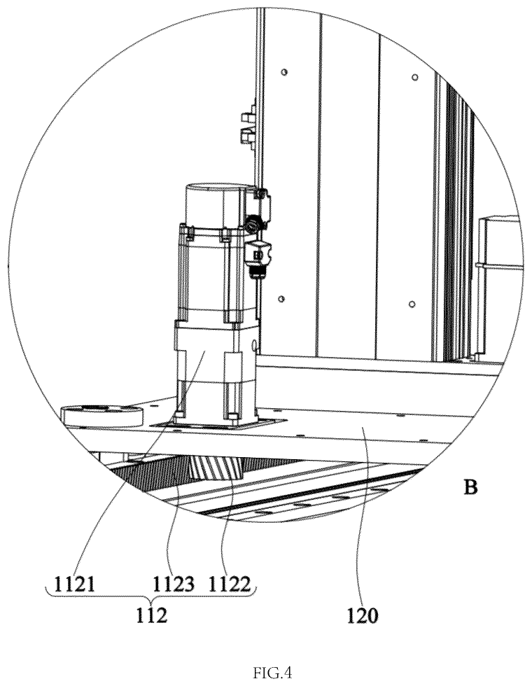

FIG. 4 is an enlarged partial view of area B in FIG. 3.

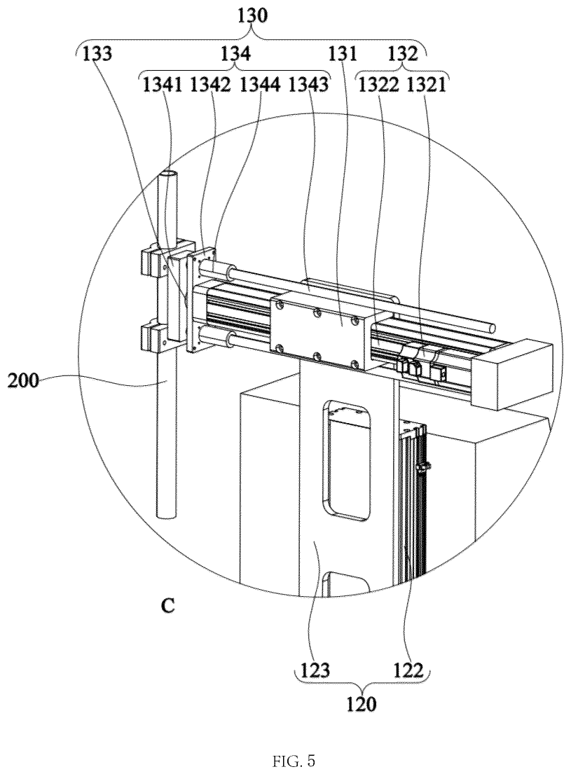

FIG. 5 is an enlarged partial view of area C in FIG. 1.

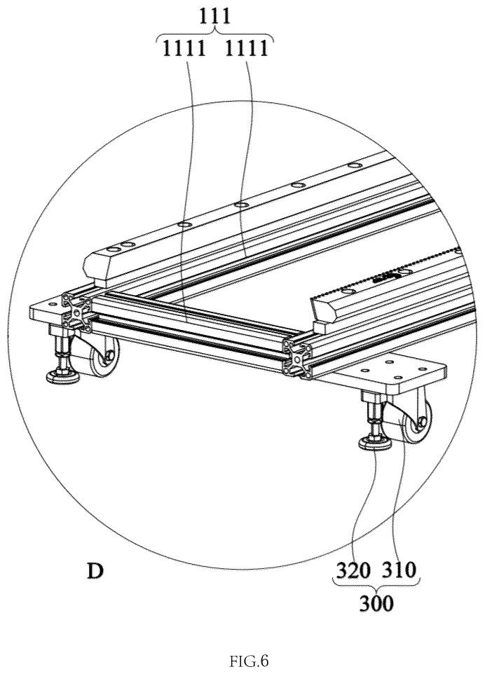

FIG. 6 is an enlarged partial view of area D in FIG. 1.

The labels in the figures are as follows:

100—support frame; 110—first support mechanism; 111—support assembly; 1111—first frame; 112—first drive assembly; 1121—first drive member; 1122—drive wheel; 113—second guiding assembly; 1131—guide rail; 1132—slider; 120—second support mechanism; 121—second frame; 122—second driving assembly; 1221—second driving member; 1222—first servo slide; 123—moving frame; 130—third support mechanism; 131—fixed seat; 132—third drive assembly; 1321—third drive member; 1322—second servo slide; 133—fourth driving assembly; 134—first guiding assembly; 1341—the first mounting frame; 1342—the second mounting frame; 1343—guide rod; 1344—guide sleeve;

200—printing head;

300—moving assembly; 310—moving wheel; 320—a support foot;

400—control mechanism.

The present patent application will be further described in detail below in conjunction with the accompanying drawings and embodiments. It should be understood that the specific embodiments described herein are only used to explain the present invention but not to limit the present invention. In addition, it should be noted that for the convenience of description, the drawings only show a part of the structure related to the present invention and not the entire structure.

In the description of the present invention, unless otherwise expressly specified and limited, the terms “connected,” “connected,” and “fixed” should be understood in a broad sense. For example, it can refer to a fixed connection, a detachable connection, or a fixed connection. It can be a mechanical connection or an electrical connection. It can be a direct connection or an indirect connection through an intermediate medium. It can denote the connection between the structures of the two elements or the interaction relationship between the two elements. The specific meanings of these terms in the present invention can be understood in specific situations by those skilled in the art.

In the present invention, unless otherwise expressly specified and limited, when a first feature is described as “on” or “under” a second feature, it may include the first and second features in direct contact, or it may include the first and second features with additional features between them. Similarly, when the first feature is described as “above,” “over,” or “on top of” the second feature, it can mean that the first feature is directly above and inclined above the second feature, or it simply indicates that the first feature is at a higher level than the second feature. Likewise, when the first feature is described as “below,” “underneath,” or “beneath” the second feature, it can mean that the first feature is directly below and inclined below the second feature, or it simply indicates that the first feature is at a lower level than the second feature.

In the description of this embodiment, the terms “up,” “down,” “left.” “right,” and other azimuthal or positional relationships are based on the azimuthal or positional relationship shown in the accompanying drawings. They are used for the convenience of description and simplifying operations, but they do not indicate or imply that the indicated device or element must have a particular orientation, be constructed and operate in a specific orientation. Therefore, they should not be construed as a limitation of the present invention. In addition, the terms “first” and “second” are used for distinction in description and have no special meaning.

Referring to FIG. 1, this embodiment provides a 3D printer for construction, which is used to print building walls using 3D printing technology.

Existing construction 3D printers, typically weighing over five tons, pose significant transportation challenges. Their substantial size demands considerable manpower and hoisting equipment for assembly prior to each print. Additionally, the printing and retracting process proves labor-intensive and time-consuming. The necessity for mobile 3D printers introduces further operations, resulting in escalated costs and increased labor.

Referring to FIG. 1, in order to solve the above problems, the 3D printer of this embodiment comprises a support frame 100 and a print head 200. The print head 200 is arranged at the output end of the support frame 100. The support frame 100 comprises a first support mechanism 110, a second support mechanism 120, and a third support mechanism 130. The first support mechanism 110 is arranged along the X direction (the first direction), the second support mechanism 120 is positioned along the Z direction (the second direction) at the output end of the first support mechanism 110, and the third support mechanism 130 is positioned along the Y direction (the third direction) at the output end of the second support mechanism 120. The print head 200 is located on the third support mechanism 130, enabling flexible movement of the print head 200 in the X direction, Z direction, and Y direction. The first support mechanism 110, the second support mechanism 120, and the third support mechanism 130 can be disassembled into three parts. The length of the second support mechanism 120 can be extended and retracted along the Z direction, and the length of the third support mechanism 130 can be extended and retracted along the Y direction, which is beneficial for reducing the volume of the 3D printer and facilitating transportation.

The 3D printer structure in this embodiment is simple and easy for operators to assemble quickly. Under normal circumstances, an operator only needs to plug in the power cord and fasten the screws to achieve fast assembly. Typically, one operator can assemble or disassemble a 3D printer in just fifteen minutes.

Preferably, the print head 200 is made of aluminum alloy material. Aluminum alloy has the advantages of low density and lightweight, which facilitates a lightweight structure for the print head 200 and easy replacement.

It should be understood that, as shown in FIG. 1, the 3D printer further comprises a control mechanism 400. The control mechanism 400 is electrically connected to the first support mechanism 110, the second support mechanism 120, and the third support mechanism 130, thereby controlling the movement and displacement of the first support mechanism 110, the second support mechanism 120, and the third support mechanism 130. To save space, the control mechanism 400 is positioned on the second support frame 121, allowing it to move along the X direction with the second support frame 121.

Referring to FIGS. 1 to 4, the detailed structure of the first support mechanism 110 will be explained.

As shown in FIGS. 1 and 2, the first support mechanism 110 includes a plurality of support assemblies 111 connected end to end along the X direction. Adjacent support assemblies 111 can be detachably connected, enabling operators to quickly assemble and disassemble the support assemblies 111 on-site. This improves the efficiency to assembly disassemble by operators on site. By dividing the conventional construction 3D printer into a plurality of support assemblies 111 along the X direction, each support assembly 111 has a smaller length, eliminating the need for hoisting equipment for assembly. This helps to reduce assembly and disassembly costs and minimize the size of the first support mechanism 110 during transportation, thereby reducing transportation costs. Simultaneously, the assembly of a plurality of support assemblies 111 facilitates the adjustment of the length of the first support mechanism 110 according to the requirements, enhancing the flexibility and applicability of the 3D printer. For example, the length of the support assemblies 111 can be designed as two meters, and the length of the first support mechanism 110 along the X direction can be extended by joining them. However, in other embodiments, the length of the support assemblies 111 can be designed as other dimensions, and this embodiment does not limit it. It should be understood that adjacent support assemblies 111 are connected by fixing elements, such as screws or bolts, as examples.

Furthermore, as shown in FIG. 2, the support assemblies 111 consist of a plurality of supporting members that are connected end to end to form a rectangular frame structure. The long side of the frame structure is in the X-direction. This structure improves the stability of the support assemblies 111 and is lightweight. As an example, the supporting members are made of aluminum alloy profiles, which further reduces the weight of the support frame 100. The lightweight structure of the support assemblies 111 facilitates easy replacement.

Optionally, as shown in FIG. 2, the first support mechanism 110 also includes a second guiding assembly 113 positioned between the support assemblies 111 and the second support mechanism 120. The second guiding assembly 113 provides guidance for the motion of the second support mechanism 120 in the X-direction, thereby enhancing the stability of the second support mechanism 120. Specifically, the second guiding assembly 113 includes a guide rail 1131 and a slider 1132. The guide rail 1131 is positioned along the X-direction on the support assemblies 111, while the slider 1132 is placed on the second support mechanism 120 and slides along the guide rail 1131. This arrangement improves the smoothness of the motion of the second support mechanism 120 in the X-direction and prevents any sticking or jamming. As a preferred option, the guide rail 1131 and slider 1132 are made of high-wear-resistant alloy steel to enhance the durability of the first driving assembly 112.

Furthermore, the second guiding assembly 113 consists of two sets of assemblies that are parallel and spaced apart on the support assemblies 111, further improving the stability of the motion of the second support mechanism 120.

At the same time, the slider 1132 can slide directly in or out at the ends of the guide rail 1131 on the support assemblies 111, facilitating disassembly and enhancing the efficiency of assembling and disassembling the 3D printer.

In this embodiment, as shown in FIGS. 3 and 4, the first support mechanism 110 further includes a first drive assembly 112. The first drive assembly 112 is positioned between the support assemblies 111 and the second support mechanism 120, and it is used to drive the second support mechanism 120 to move along the X direction. Specifically, the first drive assembly 112 comprises a first drive member 1121, a drive wheel 1122, and a rack 1123. The first drive member 1121 is positioned on the second support mechanism 120, the drive wheel 1122 is placed at the output end of the first drive member 1121, and the rack 1123 is arranged along the X direction on the support assembly. The drive wheel 1122 and the rack 1123 are engaged. During operation, the first drive member 1121 drives the drive wheel 1122 to move along the rack 1123, thereby enabling flexible movement of the second support mechanism 120 along the X direction without being limited by the number of support assemblies 111. Since the first support mechanism 110 can be connected to a plurality of support assemblies 111 along the X direction, the structure of the first drive assembly 112 is not limited by the number of support assemblies 111. This allows the second support mechanism 120 to move flexibly on a plurality of connected support assemblies 111, ensuring the flexibility of the first support mechanism 110 structure. Preferably, due to the significant wear during the movement process of the second support mechanism 120, the drive wheel 1122 and the rack 1123 are made of high-wear-resistant alloy steel, thereby improving the service life of the first drive assembly 112.

Preferably, as shown in FIGS. 2 and 4, the rack 1123 and the guide rail 1131 can be an integrated structure. The outer or inner side of the integrated structure serves as a guide rail 1131 that cooperates with the sliding block 1132, while the other side serves as a rack 1123 that cooperates with the drive wheel 1122. When the two sets of second guide assemblies 113 cooperate with each other, the two sliding blocks 1132 are arranged in opposition, ensuring that the second support mechanism 120 is stably positioned on the guide rail 1131. This integrated structure further simplifies the first support mechanism 110, making it easier for operators to assemble and improving assembly efficiency.

Now, in conjunction with FIGS. 1 and 2, the detailed structure of the second support mechanism 120 will be explained.

As shown in FIGS. 1 and 2, the second support mechanism 120 includes a second frame 121, a second drive assembly 122, and a movable frame 123. The second frame 121 is positioned on the first support mechanism 110, the second drive assembly 122 is placed on the second frame 121, and the movable frame 123 slides in cooperation with the second drive assembly 122. The second drive assembly 122 can drive the movable frame 123 to move along the Z direction, and the third support mechanism 130 is positioned on the movable frame 123. During operation, the first drive assembly 112 can drive the second frame 121 to reciprocate along the X direction on the support assemblies 111, and the second drive assembly 122 can drive the movable frame 123 to reciprocate along the Z direction. After completing the 3D printing process, the second drive assembly 122 can move the movable frame 123 to its lowest position, causing the second support mechanism 120 to contract and reduce its length along the Z direction. This reduces the overall dimensions of the 3D printer in the non-working state, making it easier to transport.

Furthermore, please refer to FIG. 2. The second drive assembly 122 includes a second drive member 1221 and a first servo slide table 1222. The first servo slide table 1222 is positioned along the Z direction on the second frame 121, and the movable frame 123 is slidably connected to the first servo slide table 1222. The structure of the second drive assembly 122 is simple and has high precision of movement, which improves the printing accuracy of the 3D printer. Additionally, the second drive assembly 122 is a fully enclosed automatic telescopic structure, which provides dust-proof, water-proof, and contamination prevention benefits, thereby increasing the service life of the second drive assembly 122. During operation, the second drive member 1221 can drive the movable frame 123 to move along the Z direction on the first servo slide table 1222. In the non-working state, the movable frame 123 is in a contracted state, which enhances the flexibility of the second drive assembly 122 and reduces its size, making it easier to transport. To improve assembly efficiency, the servo cable of the first servo slide table 1222 is equipped with a quick connector for easy disassembly. Preferably, the second drive assembly 122 is made of aluminum alloy material to reduce the weight of the third support mechanism 130.

Please refer to FIGS. 1 and 2. Preferably, the length of the movable frame 123 is the same as that of the first servo slide table 1222. When the movable frame 123 contracts, the total length of the second drive assembly 122 is only the length of the first servo slide table 1222. This facilitates minimizing the size of the second drive assembly 122 in the non-working state. Furthermore, by sliding in conjunction with the first servo slide table 1222 along the length direction of the movable frame 123, stability during the movement of the movable frame 123 along the Z direction is enhanced, allowing the movable frame 123 to extend to its highest position. This effectively utilizes the overall length of the movable frame 123, enabling the expansion of the range of movement of the print head 200 along the Y direction, thereby increasing the applicability of the 3D printer.

Now, in conjunction with FIGS. 1 and 5, the detailed structure of the third support mechanism 130 will be explained.

As shown in FIGS. 1 and 5, the third support mechanism 130 includes a fixed seat 131 and a third driving assembly 132. The fixed seat 131 is fixedly connected to the second support mechanism 120, while the third driving assembly 132 is slidably connected to the fixed seat 131. The third driving assembly 132 can drive the fixed seat 131 to move in the Y-direction, facilitating the movement of the printhead 200 in the Y-direction. The fixed seat 131 simplifies the connection between the third support mechanism 130 and the second support mechanism 120, enabling the movement of the printhead 200 in the Y-direction.

Please refer to FIG. 5 for more details. Specifically, the third driving assembly 132 consists of a third driving members 1321 and a second servo slide table 1322. The second servo slide table 1322 is positioned in the Y-direction, and the fixed seat 131 has a U-shaped structure. The second servo slide table 1322 is located in the groove of the fixed seat 131, allowing the fixed seat 131 to slide along the second servo slide table 1322 in the Y-direction. The fixed seat 131 is fixed on the mobile frame 123, and the third driving members 1321 can drive the fixed seat 131 to slide on the second servo slide table 1322. This simple and high-precision structure of the third driving assembly 132 improves the printing accuracy of the 3D printer. Moreover, the second driving assembly 122 is fully enclosed and automatically retractable, which helps to prevent dust, water, and contamination, thus increasing the lifespan of the third driving assembly 132. During operation, the third driving members 1321 can drive the fixed seat 131 to move in the Y-direction on the second servo slide table 1322, enhancing the versatility of the second driving assembly 122, and its compact size facilitates transportation. To improve assembly efficiency, the servo cable of the second servo slide table 1322 adopts a quick-connect interface for easy disassembly. Preferably, the second driving assembly 122 is made of aluminum alloy material to reduce the weight of the third support mechanism 130.

Please continue referring to FIG. 5. Furthermore, the third support mechanism 130 includes a fourth driving assembly 133 mounted on the third driving assembly 132. The printhead 200 is positioned at the output end of the fourth driving assembly 133. The fourth driving assembly 133 can drive the printhead 200 to perform telescopic motion in the third direction, thereby expanding the range of motion of the printhead 200 in the Y-direction on the third support mechanism 130 and increasing the printing range of the 3D printer. Specifically, the third driving assembly 132 is a telescopic cylinder, which has a simple structure, low cost, and high precision in reciprocating motion. Through the coordination of the third driving assembly 132 and the fourth driving assembly 133, the motion range of the printhead 200 in the Y-direction is the sum of the length of the second servo slide table 1322 and the maximum stroke of the telescopic cylinder. This significantly expands the travel distance of the printhead 200 in the Y-direction. Moreover, in the non-working state, the telescopic cylinder of the third support mechanism 130 is in a retracted state, minimizing the size of the 3D printer in the Y-direction, which reduces the volume and transportation cost.

To improve the precision of the printhead 200 in the Y-direction, the third support mechanism 130 further includes a first guiding assembly 134 positioned between the printhead 200 and the third driving assembly 132. The first guiding assembly 134 provides guidance for the motion of the printhead 200 in the third direction.

Please continue referring to FIG. 5. Specifically, the first guiding assembly 134 includes a first mounting bracket 1341, a second mounting bracket 1342, and a guide rod 1343. The first mounting bracket 1341 is positioned at the output end of the fourth driving assembly 133 and is fixedly connected to the printhead 200. The second mounting bracket 1342 is located on the third driving assembly 132, and one end of the guide rod 1343 is fixed to the first mounting bracket 1341. The second mounting bracket 1342 has a guide hole extending in the Y-direction, allowing the guide rod 1343 to slide within the guide hole. When the fourth driving assembly 133 drives the first mounting bracket 1341 to perform telescopic motion in the Y-direction, the guide rod 1343 reciprocates within the guide hole, providing guidance for the motion of the first mounting bracket 1341 and improving its precision and stability, thereby preventing any sticking. Optionally, the fourth driving assembly 133 is connected to the center position of the first mounting bracket 1341, and there are two guide rods 1343, each set on either side of the second servo slide table 1322, thereby preventing the printhead 200 from rotating and further enhancing the stability of the motion of the first mounting bracket 1341.

In other embodiments, one end of the guide rod 1343 is fixed to the second mounting bracket 1342, and the first mounting bracket 1341 has a guide hole extending in the Y-direction, allowing the guide rod 1343 to slide within the guide hole. This configuration is the same in terms of motion but differs in the positioning of the guide rod 1343 and the guide hole, and thus is not further elaborated here.

As shown in FIG. 5, in other embodiments, the first guiding assembly 134 further includes a guide sleeve 1344, which is positioned on the first mounting bracket 1341 or the second mounting bracket 1342 without fixing the guide rod 1343. The guide rod 1343 passes through the guide sleeve 1344, thereby increasing the length of the guide hole and further enhancing the stability of the motion of the printhead 200.

Preferably, as shown in FIGS. 1 and 6, the construction 3D printer further includes a mobile assembly 300, which is positioned on the first support mechanism 110 and facilitates the movement and support of the first support mechanism 110. Specifically, the mobile assembly 300 comprises a plurality of mobile rollers 310, which are divided into two groups and placed on opposite sides of the support assemblies 111, providing stable support for the first support mechanism 110. This facilitates the quick transportation of the 3D printer on-site and allows it to be moved to a specified location for building printing without disassembly. As an example, each group of mobile rollers 310 consists of three, resulting in six mobile rollers 310 being set on each support assembly 111, providing stable support for the support assemblies 111 and enhancing the safety of moving the 3D printer. However, in other embodiments, the number of mobile rollers 310 can be four, eight, or any other quantity, without limitation in this embodiment.

Furthermore, the mobile assembly 300 also includes a plurality of support feet 320, which are also divided into two groups and placed on opposite sides of the support assemblies 111. When the 3D printer is moved to the working position, the support feet 320 can stably support the first support mechanism 110 and prevent the movement of the support assemblies 111 during operation. As an example, each group of support feet 320 consists of three, resulting in six support feet 320 being set on each support assembly 111, providing stable support for the support assemblies 111 and enhancing the safety of moving the 3D printer. However, in other embodiments, the number of support feet 320 can be four, eight, or any other quantity, without limitation in this embodiment. Preferably, the support feet 320 are adjustable, allowing the operator to adjust their height and maintain the horizontal position of the 3D printer on uneven surfaces, thereby improving the printing accuracy of the 3D printer.

Optionally, the support feet 320 are positioned adjacent to the mobile rollers 310, facilitating assembly and height adjustment by the operator.

It should be noted that the above description and illustration of the present patent application disclose its basic principles, main features, and advantages. Those skilled in the art should understand that the present patent application is not limited to the above-described embodiments. The embodiments and descriptions provided are only illustrative of the principles of the present patent application. Various modifications and improvements may be made without departing from the spirit and scope of the present patent application, which are defined by the appended claims and their equivalents.

1. An architectural 3D printer, comprising a support frame (100) and a print head (200), wherein the support frame (100) comprises:
a first support mechanism (110) comprising multiple support assemblies (111) connected end to end along a first direction, wherein adjacent support assemblies (111) are detachably connected;
a second support mechanism (120) positioned at an output end of the first support mechanism (110) along a second direction, and a length of the second support mechanism (120) is extendable and retractable along the second direction;
a third support mechanism (130) positioned at the output end of the second support mechanism (120) along a third direction, and a length of the third support mechanism (130) is extendable and retractable along the third direction; and
the print head (200) is positioned at an output end of the third support mechanism (130), and the first direction, the second direction, and the third direction are mutually perpendicular to each other.

2. The architectural 3D printer according to claim 1, wherein the first support mechanism (110) further comprises:
a first driving assembly (112) positioned between the support assemblies (111) and the second support mechanism (120), the first driving assembly (112) being configured to drive the second support mechanism (120) to move along the first direction.

3. The architectural 3D printer according to claim 2, wherein the first driving assembly (112) comprises:
a first driving element (1121) positioned on the second support mechanism (120);
a driving wheel (1122) connected to the output end of the first driving element (1121); and
a rack (1123) in mesh with the driving wheel (1122), extending along the first direction and positioned on the support assemblies (111).

4. The architectural 3D printer according to claim 1, wherein the second support mechanism (120) comprises:
a second frame (121) positioned on the first support mechanism (110);
a second driving assembly (122) positioned on the second frame (121);
a movable frame (123) slidingly engaged with the second driving assembly (122); and wherein the second driving assembly (122) is configured to drive the movable frame (123) to move along the second direction, and the third support mechanism (130) is positioned on the movable frame (123).

5. The architectural 3D printer according to claim 4, wherein the second driving assembly (122) comprises:
a second driving element (1221).
a first servo slide table (1222) positioned on the second frame (121) along the second direction, with the movable frame (123) slidingly connected to the first servo slide table (1222), wherein the second driving element (1221) is configured to drive the movable frame (123) to perform telescopic motion on the first servo slide table (1222) along the second direction.

6. The architectural 3D printer according to claim 1, wherein the third support mechanism (130) comprises:
a fixed seat (131) fixedly connected to the second support mechanism (120);
a third driving assembly (132) slidably connected to the fixed seat (131); and wherein the third driving assembly (132) is capable of driving the fixed seat (131) to move along the third direction.

7. The architectural 3D printer according to claim 6, wherein the third support mechanism (130) further comprises:
a fourth driving assembly (133) positioned on the third driving assembly (132), with the print head (200) positioned at the output end of the fourth driving assembly (133), wherein the fourth driving assembly (133) is capable of driving the print head (200) to perform telescopic motion along the third direction.

8. The architectural 3D printer according to claim 7, wherein the third support mechanism (130) further comprises:
a first guiding assembly (134) positioned between the print head (200) and the third driving assembly (132), wherein the first guiding assembly (134) is configured to provide guidance for the motion of the print head (200) along the third direction.

9. The architectural 3D printer according to claim 8, wherein the first guiding assembly (134) comprises:
a first mounting bracket (1341) positioned at the output end of the fourth driving assembly (133), and the first mounting bracket (1341) is fixedly connected to the print head (200);
a second mounting bracket (1342) positioned on the third driving assembly (132);
a guide rod (1343) with one end fixed to either the first mounting bracket (1341) or the second mounting bracket (1342), and the first mounting bracket (1341) and the second mounting bracket (1342) that are not fixed with the guide rod (1343) are provided with guide holes extending along the third direction, wherein the guide rod (1343) is capable of sliding in the guide holes.

10. The architectural 3D printer according to claim 1, further comprising a moving assembly (300) positioned on the first support mechanism (110), wherein the moving assembly (300) is configured to move and support the first support mechanism (110).

11. A method to print an architecture, comprising:
providing an architectural 3D printer, comprising a support frame (100) and a print head (200), wherein the support frame (100) comprises:
a first support mechanism (110) comprising multiple support assemblies (111),
a second support mechanism (120) and a third support mechanism (130); and
the print head (200);
connecting multiple support assemblies end to end along a first direction to form a first support mechanism, ensuring adjacent support assemblies are detachably connected;
positioning a second support mechanism at the output end of the first support mechanism along a second direction, and adjusting its length along the second direction as per requirement;
positioning a third support mechanism at the output end of the second support mechanism along a third direction, and adjusting its length along the third direction as per requirement;
positioning the print head at an output end of the third support mechanism, ensuring the first direction, the second direction, and the third direction are mutually perpendicular to each other.

13. The method of claim 11, further comprising
driving the second support mechanism using a first driving assembly positioned between the support assemblies and the second support mechanism to move along the first direction.

14. The method of claim 11, further comprising
engaging a rack with a driving wheel connected to the output end of a first driving element positioned on the second support mechanism, extending the rack along the first direction and positioning it on the support assemblies.

15. The method of claim 11, further comprising
positioning a movable frame on a second frame of the second support mechanism and driving the movable frame to move along the second direction with a second driving assembly, and positioning the third support mechanism on the movable frame.

16. The method of claim 11, further comprising
driving the movable frame to perform telescopic motion on a first servo slide table along the second direction using the second driving element.

17. The method of claim 11, further comprising
driving a fixed seat connected to the second support mechanism to move along the third direction using a third driving assembly slidably connected to the fixed seat.

18. The method of claim 11, further comprising
driving the print head to perform telescopic motion along the third direction using a fourth driving assembly positioned on the third driving assembly with the print head positioned at the output end of the fourth driving assembly.

19. The method of claim 11, further comprising
providing guidance for the motion of the print head along the third direction using a first guiding assembly positioned between the print head and the third driving assembly.

20. The method of claim 11, further comprising
allowing a guide rod to slide in guide holes extending along the third direction in either a first mounting bracket or a second mounting bracket not fixed with the guide rod; and
moving and supporting the first support mechanism with a moving assembly positioned on the first support mechanism.
